(19) United States
(12) Patent Application Publication
(10) Pub. No.: US 2005/0255430 A1
(43) Pub. Date: Nov. 17, 2005

(54) Speech instruction method and apparatus

(76) Inventors: Robert Kalinowski, Hawthorne, CA (US); George Kammerer, Torrance, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/119,415

(22) Filed: Apr. 29, 2005

Related U.S. Application Data
(60) Provisional application No. 60/566,612, filed on Apr. 29, 2004.

(51) Int. Cl. G09B 19/04

(52) U.S. Cl. 434/169

(57) ABSTRACT

Interactive systems, methods and apparatus for teaching the English language can utilize an audio-visual program allowing a user to choose and study particular sounds. The audio-visual program can have a menu-driven program allowing a user to selectively choose the particular sound to be practiced. Once a desired sound is selected, a simulated lower head profile can simultaneously “speak” the desired sound while visually depicting the movement and positioning of facial features such as, for example, the lips, jaws, teeth, tongue and throat. The audio-visual program is controllable by the user so as to allow maneuverability from one sound to the next and to allow sounds to be repeated as many times as desired by the user.

### PRIORITY CLAIM

The present application claims priority to U.S. Provisional Application No. 60/566,612, filed Apr. 29, 2004, entitled, “SPEECH INSTRUCTION METHOD AND APPARATUS,” which is hereby incorporated by reference in is entirety.

### FIELD OF THE INVENTION

The present invention relates to the teaching of language and/or speech skills. More specifically, the present invention provides for a method and apparatus for interactive teaching of language and/or speech skills.

### BACKGROUND OF THE INVENTION

In general, the conventional American English speech instruction method can comprise various combinations of steps such as:
Giving the student written/verbal directions on how to form the sounds;
Having the student look in a mirror and notice specific physical elements indigenous to the particular sound;
Having the student hold his hand in front of his mouth and feel where the air is coming from (off the upper lip, the lower lip, through the nose, etc.);
Having the student put a finger behind/below his ear, or on his throat or nose to feel the sound and told how the correct sound should feel;
Encouraging the student to use words in his native language that have the same sound and perform the physical test to determine if the sounds are the same or different;
Presenting American words that have the sound being taught; and
Presenting some homonyms.

While these steps do provide some degree of success, they are not optimal in that many of the sounds particular to the English language remain difficult to pronounce even with these steps. This is especially true for non-English speakers whose first language lacks certain sounds that are commonly found and used when speaking English. As such, it would be advantageous to have an advanced teaching tool to provide non-English speakers with the mechanical ability to understand and speak these new English sounds.

### SUMMARY OF THE INVENTION

An interactive system for teaching the English language can comprise an audio-visual program allowing a user to choose and study particular sounds. The audio-visual program can comprise a menu-driven program allowing a user to selectively choose the particular sound to be practiced. Once a desired sound is selected, a simulated lower head profile can simultaneously “speak” the desired sound while visually depicting the movement and positioning of facial features such as, for example, the lips, jaws, teeth, tongue and throat. The audio-visual program is controllable by the user so as to allow maneuverability from one sound to the next and to allow sounds to be repeated as many times as desired by the user.

In one aspect of the present invention, a method for teaching spoken English comprises selecting a displayed English sound from a sound menu of an interactive audio-visual program followed by viewing the movement of a cut-away profile of a lower facial region of a simulated human speaker as the selected English sound is spoken. The method can be repeated as many times as necessary or desired by the user to perfect the pronunciation of the English sound. In addition, the method can comprise reading a corresponding text describing the movement of the lower facial region for the selected English sound.

In another aspect of the present invention, an instructional kit for teaching non-English speakers the English language can comprise an interactive program for visually simulating the movement and positioning of facial features during the speaking of English sounds and a speech instruction text describing the movements depicted in the interactive computer program. The interactive program can comprise any suitable format suitable for use with commonly available consumer electronics such as, for example, personal computers, DVD players, video game systems and on-demand transmission systems.

In another aspect of the present invention, an interactive system for teaching English can comprise a processor system for reading and executing a set of readable instructions and an audio-visual program formed of readable instructions. The audio-visual program and processor can in combination prompt a user to select a desired sound from a directory of English sounds wherein the desired sound is then presented to the user through a cut-away profile of a lower facial region of a simulated human speaker so as to illustrate the movement of the lower facial region in making the desired sound. The audio-visual program can comprise suitable formats for reading by the processor systems including formats such as, for example, a DVD, a CD-ROM, a portable memory device, a floppy diskette, a downloadable computer file, and an on-demand or streaming signal transmission.

### BRIEF DESCRIPTION OF THE DRAWINGS

FIG. 1 is a screen shot of an embodiment of a menu page from an audio-visual interface for teaching spoken English.

FIG. 2 is a screen shot of an embodiment of a sound selection page from the audio-visual interface of FIG. 1.

FIG. 3 is a screen shot of a side, phantom view of a lower face for depicting the formation of a selected sound from the English language.

FIG. 4 is a screen shot of a perspective, phantom view of the lower face for depicting the formation of a selected sound from the English language.

FIG. 5 is a screen shot of a side, phantom view of the lower face for depicting the formation of a selected sound from the English language.

FIG. 6 is a screen shot of a perspective, phantom view of the lower face for depicting the formation of a selected sound from the English language.

FIG. 7 is a screen shot of a perspective, phantom view of the lower face for depicting the formation of a selected sound from the English language.

FIG. 8 is a screen shot of a perspective, phantom view of the lower face including a representative x-y-z axis for rotation of the lower face in one embodiment of the audio-visual English learning system.

FIG. 9 is a perspective view of a user using an embodiment of the audio-visual English learning system on a personal computer.

### DETAILED DESCRIPTION OF THE PREFERRED EMBODIMENTS

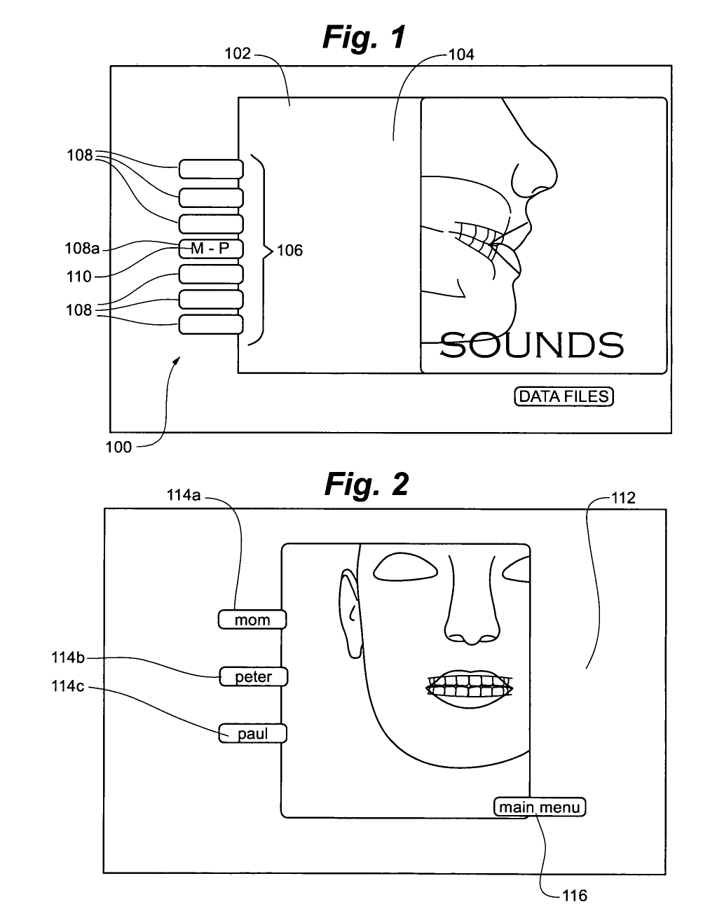

As illustrated in FIG. 1, an audio-visual English language learning system 100 can comprise an interactive program 102 allowing for non-English speakers to learn the sounds and pronunciation of the English language at their own pace and under their own control. Interactive program 102 can comprise a format suitable for use on commonly found electronic devices such as, for example, personal computers, DVD players, video game systems, and on-demand transmission systems such as broadband cable or digital satellite transmissions. In some embodiments, interactive program 102 can be used with a portable devices such as, for example, a portable DVD player, so as to allow the user to use interactive program 102 in a variety of settings such as in a car, at home, in school and the like. As illustrated in the following pictures and as described throughout the application, reference will be made to the use of interactive program 102 on a personal computer. It will be understood that this is for illustrative purposes only and that any of the previously referenced devices and formats as well as other like device and formats could be similarly employed by a user.

With reference to FIG. 1, interactive program 102 can comprise a directory screen 104 providing a selectable sound menu 106 such that the user can selectively choose the sound type that they desire to practice. This can provide the user with an ability to proceed in a sequential, alphabetical manner through the various English sounds or alternatively, the user can select sounds in which they desire to place extra emphasis on or sounds that are most frequently used in the English language. Selectable sound menu 106 can comprise a plurality of selectable tabs 108 providing the user with an ability to quickly and easily direct the interactive program 102 to the desired sound selection. Any number of selectable tabs 108 can be employed on selectable sound menu 106 and each selectable tab 108 can comprise a sound range 110 such as, for example, “M-P,” as depicted on selectable tab 108a. Using a suitable interface device such as, for example, a computer keyboard, mouse, joystick, video game controller, remote control, touch screen or other similar device, the user can select the desired tab corresponding to the desired English sound.

For purposes of illustration, a user choosing selectable tab 108a is directed to a sound selection screen 112 as shown in FIG. 2. Sound selection screen 112 comprises a plurality of sound tabs 114 corresponding to typical English language sounds within the sound range of selectable tab 108a. As shown in FIG. 2, a first sound tab 114a lists the word “mom,” a second sound tab 114b lists the work “Peter,” and a third sound tab 114c lists the word “Paul.” In addition, sound selection screen 112 can comprise a main menu tab 116 allowing the user to return to the directory screen 104 at any time. Using the interface device, the user selects the desired sound tab 114, for example, “mom” on sound tab 114a for practice. As illustrated in FIG. 2, each letter of the English language may comprise multiple English sounds for example the differing sounds of the letter “P” as pronounced in “Peter,” “Paul” and “Phil”. As such, audio-visual English language learning system 100 can comprises upwards of ninety different English sounds.

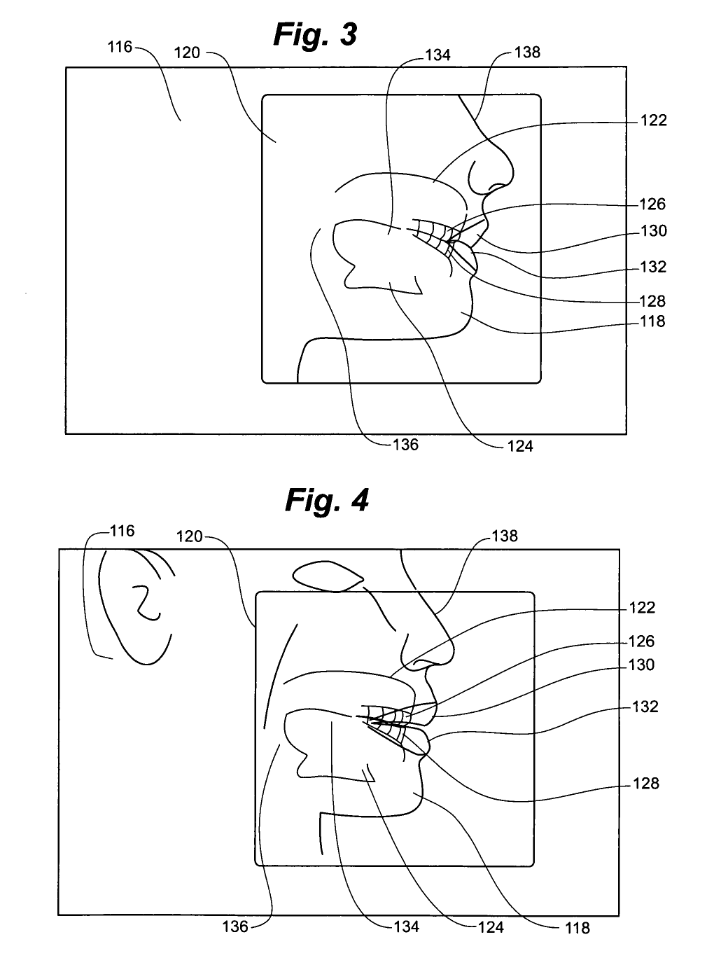

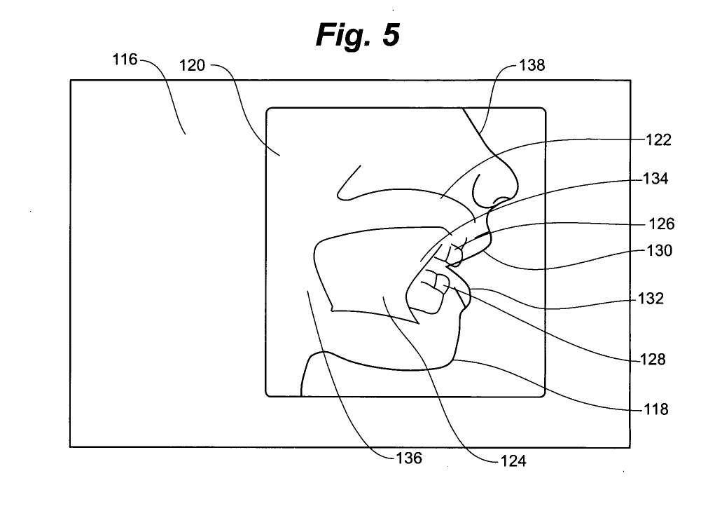

After selecting sound tab 114a, interactive program 102 directs the user to an animated sound profile screen 116 as illustrated in FIGS. 3, 4, 5, 6 and 7. Animated sound profile screen 116 comprise a partially hidden facial profile 118 of a simulated person 120. Partially hidden facial profile 118 depicts the internal position and orientation of upper jaw 122, lower jaw 124, upper teeth 126, lower teeth 128, upper lip 130, lower lip 132, tongue 134 and throat 136. Interactive program 102 contains an audio file corresponding to the selected sound tab, in the present case, “mom” from sound tab 114a such that the partially hidden facial profile 118 essentially “speaks” the word mom as the upper jaw 122, lower jaw 124, upper teeth 126, lower teeth 128, upper lip 130, lower lip 132, tongue 134 and throat 136 move in conjunction with the sound of the word. As such, a user hearing the word “mom” simultaneously sees the proper orientation and positioning of the upper jaw 122, lower jaw 124, upper teeth 126, lower teeth 128, upper lip 130, lower lip 132, tongue 134 and throat 136 and can then mimic this positioning and orientation so as to properly pronounce the English word. This mimicking process is especially valuable when a user's first language does not contain and/or use sounds that are found in the English language such that the user has no previous experience in forming the sound. In addition, as facial profile 118 “speaks” the English sound, air flow originating in throat 136 and exiting through the mouth and/or nose can be animated to further assist the user in properly mimicking the English sound. Using the interface device, the user can replay the selected sound as many times as desired and can stop the animation of facial profile 118 at any point as the selected sound is “spoken.” For a particular English sound, a user session may last from several minutes to an hour or more. In addition, a user can use a mirror to view themselves as the practice the English sound to compare their speech mechanics with the illustrations of interactive program 102.

As illustrated in FIGS. 3, 4 and 5, the word from the selected sound tab, in this case “mom” from sound tab 114a, is first spoken while viewing facial profile 118 from a side view 138. Side view 138 provides the user with a detailed view of the relative positioning of upper jaw 122, lower jaw 124, upper teeth 126, lower teeth 128, upper lip 130, lower lip 132, tongue 134 and throat 136, with respect to one another and the gaps and distances necessary to properly form the English sounds.

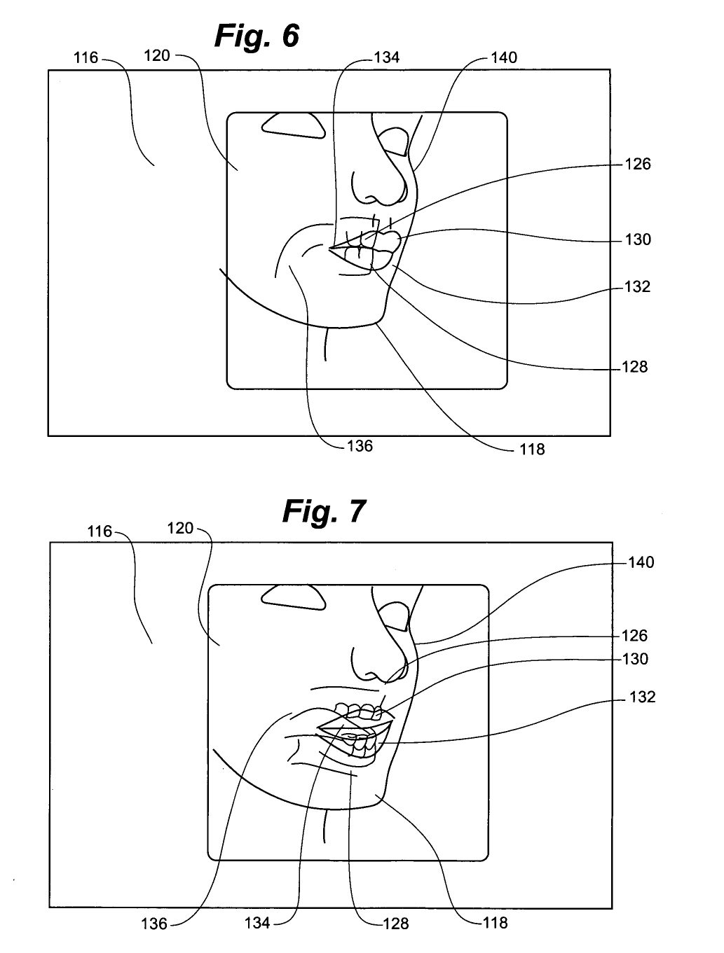

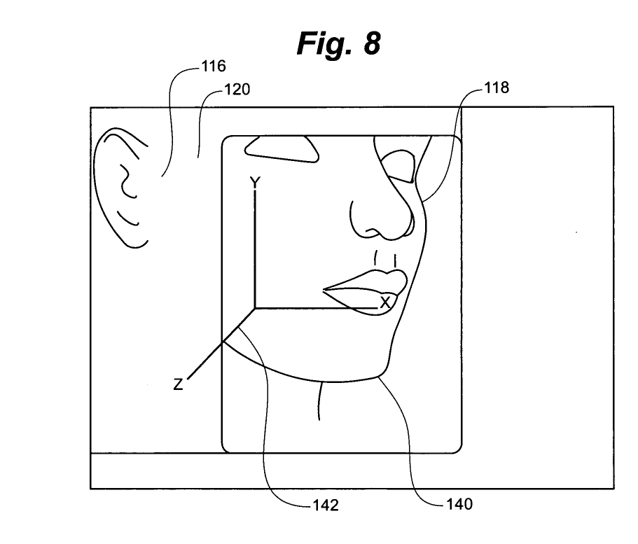

After viewing the word “mom” spoken from side view 138, interactive program 102 rotates the facial profile 118 to a front perspective view 140 illustrated in FIGS. 6 and 7 and repeats the word “mom.” When viewing front perspective view 140, the user can clearly see how upper lip 130 and lower lip 132 are shaped and positioned to properly form the English sound. In another embodiment of interactive program 102, the user can utilize the interface device to selectively turn and view the facial profile 118 about an x-y-z axis 142, as illustrated in FIG. 8, to provide the user with any desirable view for seeing the movement of upper jaw 122, lower jaw 124, upper teeth 126, lower teeth 128, upper lip 130, lower lip 132, tongue 134 and throat 136 as the English sound is spoken.

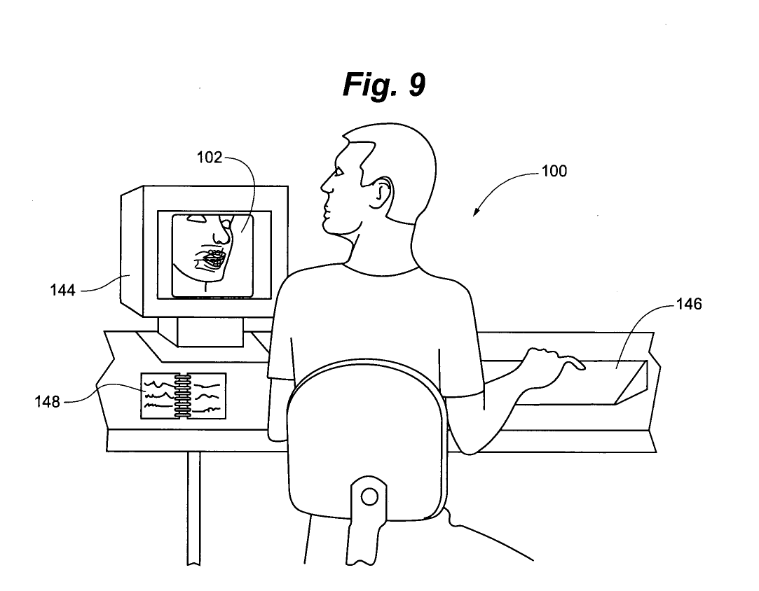

Use of the audio-visual English language learning system 100 by a user is illustrated in FIG. 9. Utilizing a personal computer 144, the user interacts with interactive program 102 utilizing a control interface 146, depicted as a computer keyboard. Audio-visual English language learning system 100 can further comprise an instructional text 148 such as, for example, the instructional text included as Appendix A in U.S. Provisional Application Serial No. 60/55,612 which was previously incorporated by reference in its entirety, for providing the user with a written description of English pronunciation and various facial movements that occur during speaking of selected English sounds. Instructional text 148 can comprise a written description corresponding to each one of the sound tabs 114 contained within interactive program 102. Through the use of audio-visual English language learning system 100 and instructional text 148, the user can simultaneously experience the three mechanisms by which people learn: hearing, reading, saying. Audio-visual English language learning system 100 is especially applicable for users such as, for example, children and adults with speech defects, English-speakers recovering from a stroke, foreign schools training employees to converse with English speakers, elementary schools working with children who are newly introduced to the English language and ESL (English as a Second Language) schools. Users of audio-visual English language learning system 100 will preferably have a basic understanding of the English language, such as, for example, an ability to understand and follow verbal and/or written English instructions prior to using the audio-vidual English language learning system 100.

Although the present invention has been described with reference to particular embodiments, one skilled in the art will recognize that changes may be made in form and detail without departing from the spirit and the scope of the invention. For example, the interactive audio-visual system could be similarly used and structure to teach languages other than English. Therefore, the illustrated embodiments should be considered in all respects as illustrative and not restrictive.

1. A method for teaching non-English speakers the English language comprising:
selecting a displayed English sound from a sound menu of an audio-visual program; and
viewing movement of a cut-away profile of a lower facial region of a simulated human speaker as the English sound is spoken.

2. The method of claim 1, further comprising:
speaking the English sound by mimicking the movement displayed by the cut-away profile.

3. The method of claim 1, wherein selecting the displayed English sound comprises manipulating a selection component selected from the group comprising: a computer keyboard, a computer mouse, a joystick, a game controller, a remote control and a touch screen.

4. The method of claim 1, wherein viewing movement of the cut-away profile comprises viewing movement facial portions selected from the group comprising: upper and lower teeth, upper and lower jaw, tongue, cheeks and throat.

5. The method of claim 1, further comprising the step of:
reading a speech instruction text describing the movement of the cut-away profile related to the spoken English sound.

6. An instructional kit for teaching non-English speakers the English language comprising:
an interactive computer animated program having a plurality of simulated speaking profiles wherein each simulated speaking profile has a related cut-away profile of a lower facial region displaying movement of the lower facial region as the simulated speaking profile is spoken; and
a speech instruction text describing the movement of the lower facial region as the simulated speaking profile is spoken.

7. The instructional kit of claim 6, wherein the interactive computer animated program comprises a sound directory wherein a user selectively chooses one of the desired simulated speaking profiles to be spoken.

8. The instructional kit of claim 7, wherein the user selects the desired simulated speaking profile with a selection component selected from the group comprising: a computer keyboard, a computer mouse, a joystick, a game controller, a remote control and a touch screen.

9. The instructional kit of claim 6, wherein the interactive computer program is accessible on a storage media selected from the group comprising: a DVD, a CD-ROM, a portable memory device, a floppy diskette, a downloadable computer file, and an on-demand transmission.

10. An interactive system for teaching English comprising:
a processor system for reading and executing a set of readable instructions; and
an audio-visual program comprising readable instructions, wherein the readable instructions prompt a user to select a desired sound from a director of English sounds and wherein the desired sound is presented to the user through a cut-away profile of a lower facial region of a simulated human speaker so as to illustrate the movement of the lower facial region in making the desired sound.

11. The interactive system of claim 10, wherein the processor system is selected from the group comprising: a personal computer, a video game console, a DVD player and an on-demand receiver.

12. The interactive system of claim 10, wherein the processor system comprises a selection device for interfacing with the audio-visual program for selecting the desired sound.

13. The interactive system of claim 12, wherein the selection device is selected from the group comprising: a computer keyboard, a computer mouse, a joystick, a game controller, a remote control and a touch screen.

14. The interactive system of claim 12, wherein the selection device provides the user to selectively alter the cut-away profile of the simulated human speaker.

15. The interactive system of claim 10, wherein the audio-visual program is provided to the processor in a format selected from the group comprising: a DVD, a CD-ROM, a portable memory device, floppy diskette, a downloadable computer file, and an on-demand transmission.

16. The interactive system of claim 10, wherein movement of the lower facial region comprises movement of one or more of the upper and lower teeth, upper and lower jaw, tongue, cheeks and throat.

17. The interactive system of claim 10, further comprising an instructional text describing the movement of the lower facial region in making the desired sound.
